(19) United States
(12) Patent Application Publication
(10) Pub. No.: US 2008/0086473 A1
(43) Pub. Date: Apr. 10, 2008

(54) COMPUTERIZED MANAGEMENT OF GROUPING ACCESS RIGHTS

(75) Inventors: Kenneth Searl, Wayzata, MN (US); Michael Obershaw, Mound, MN (US)

Correspondence Address: SCHWEGMAN, LUNDBERG & WOESSNER, P.A., P.O. BOX 2938, MINNEAPOLIS, MN, 55402, US

(73) Assignee: Prodigen, LLC

(21) Appl. No.: 11/539,450

(22) Filed: Oct. 6, 2006

(51) Int. Cl. G06F 17/30

(52) U.S. Cl. 707/9

(57) ABSTRACT

Methods and apparatus determine a set of transactions that may be assigned to a grouping within a computer system or application. The set of transactions may be analyzed and assigned on the basis of statistical analysis of the actual usage versus current authorizations. In addition, the set of transactions may be analyzed for policy conflicts. The assignment of transactions to groupings may further be determined according to the presence of policy conflicts. Additionally, groupings may be assigned to users based on organizational characteristics such as membership in a company, division, department, business unit, or vocation.

### RELATED FILES

This application is related to U.S. patent application Ser. No. 10/779,334 entitled “MONITORING AND ALERT SYSTEMS AND METHODS”, filed Feb. 13, 2004, which is a continuation-in-part of U.S. patent application Ser. No. 10/366,834 entitled “MONITORING AND ALERT SYSTEMS AND METHODS”, filed Feb. 14, 2003; each of which are hereby incorporated by reference for all purposes.

### FIELD

The present invention relates generally to computer systems and more particularly to assigning transactions to groupings in computer monitoring systems.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2003, 2004, 2006 Prodigen, LLC All Rights Reserved.

### BACKGROUND

Many computerized systems today include security software routines to manage what access is permissible for accessing various resources available within a network of computers for a given user. Resources can take on many forms, such as a particular domain within a network, various platforms such as UNIX, WINDOWS, AIX, RACF, ACF2, and applications such as SAP, PeopleSoft, as well as business transactions within an application, a folder or file etc. The security software is often times constructed to utilize groupings of users and resources to assign access rights. These groupings can be applied in some platforms depending on the capabilities of the platform being utilized. For example, in Windows they are established as “Groups”. In more advanced provisioning systems as well as some directory management solutions they have come to be known as “Roles” in support of RBAC (Role Based Access Control). RBAC is based upon the theory that given an individual's position and job responsibilities within an organization, a “Role” should be developed which will automatically grant access to all required resources within the computing environment while at the same time honoring the “Least Privilege ” best practice.

Typically groupings within most computing platforms are established to gather a series of resources that are complimentary to one another and are used in practice by a segment of the user population that perform similar if not identical tasks in the performance of their daily responsibilities. The process for determining what resources should be authorized when assigned the particular grouping is typically accomplished through a series of interviews with key management personnel in an attempt to identify what access authorizations are perceived to be required for a set of users. Most supervisors or managers charged with making these decisions for reasons of convenience, fear of losing access to a required resource, or a general lack of knowledge about the vast array of resources available will claim to need broader access to perform their daily tasks than is actually required or desirable. Due to this fact, the manual approach to establishing the groupings often ends up resulting in groupings being created with far greater authorizations than the actual execution of the tasks requires.

An alternative approach available today utilizes available products on the market which perform an electronic evaluation of what each users current authorizations are in existing systems. (This approach assumes the current authorizations accurately reflect what the true needs are.) Not unlike the manual approach, when applying the automated method using the existing authorizations from current systems to establish what resources should be assigned to the new groupings will similarly result in the creation of new or revised groupings containing authorizations that are typically far in excess of what is truly required. It is widely accepted that recent laws such as Sarbanes Oxley, have caused many companies to look closely at current authorizations, and the results have revealed that these are largely out of control due to accumulated rights over time, where individuals may have moved around in a company gaining additional authorizations without the removal of their previous rights that are no longer justified.

The efforts involved in pre-determining what resources should make up a grouping can be difficult and complex. This is further complicated when introducing the assurance that when assigning a grouping to a given user that it will not result in the creation of a separation of duties conflict or other company policy violations.

### BRIEF DESCRIPTION OF THE DRAWINGS

FIG. 1 shows a functional block diagram of the overall processing of a method and the major modules constituting a transaction monitoring and alert system according to an embodiment of the invention.

FIG. 2 shows a block diagram of an activity profile builder according to an embodiment of the invention for developing user profiles of transaction activity within specific applications being monitored.

FIG. 3 shows a block diagram of a transaction identification builder and maintenance function according to various embodiments of the invention.

FIG. 4 shows a block diagram of a client identification builder and maintenance function according to various embodiments of the invention.

FIG. 5 shows a block diagram of a transaction monitoring and alert system according to an embodiment of the invention.

FIG. 6 shows a block diagram of a computer on which embodiments of the invention may execute.

FIGS. 7A and 7B show block diagrams of a Group Builder/Refiner according to embodiments of the invention for developing groupings for applications or systems.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

As used herein, a grouping refers to any system or method used in computerized solutions that provides an authorization process to approve access to resources or transactions maintained by system. These can include but are not limited to generally understood terms such as “Roles”, “Groups”, “RBAC”, “Group Memberships” etc.

As used herein, a transaction generally refers to an activity within a computerized system that initiates access to a computing platform, a computer application, an activity within a computer application that performs specific functions, the retrieval of data from a specific directory, folder, file, data record or data element within a data store, an event recorded by an operating system, firewall, operating system and network operating systems, directory management systems, application etc.

As used herein, resources may include applications, application platforms, files, directories, databases or other elements used by a platform or application. Additionally, a transaction may also be referred to as a resource.

In the Figures, the same reference number is used throughout to refer to an identical component which appears in multiple Figures. Signals and connections may be referred to by the same reference number or label, and the actual meaning will be clear from its use in the context of the description.

The following detailed description is, therefore, not to be taken in a limiting sense, and the scope of the present invention is defined only by the appended claims.

### Overview

One aspect of the systems and methods described herein is to utilize the behavioral profiles of resources actually utilized by authorized users established through the use of the monitoring and alert system. In some implementations, a system uses as the source of activity, real time collection of events or optionally detailed transaction logs containing historical resource activity inherent within the platform or application. These sources of data represent the real needs of computer users to perform their required tasks, not the perceived needs of a supervisor or manager charged with making these decisions or simply assuming the current authorizations for a given user to a given resource reflects their actual needs. These behavioral profiles may then be used to establish the actual resources required by each authorized user to perform their functions. This baseline of transactions used by individual users may then be made available for the apparatus to perform analytical methods to identify groups of users within organizational constraints that contain identical or similar resource requirements for all or a sub-set of the resources.

A further aspect includes a method of extracting the current authorizations and permissions from each authentication source (Platform application etc.) using generally available “off the shelf” extraction techniques and software.

A further aspect includes a method of comparing and contrasting the current authorizations of an individual or group of individuals to their actual requirements based upon the behavioral profiles established through the monitoring system. This introduces a previously unavailable element of information that dramatically impacts the decision making process when determining what resources a particular grouping should authorize. If the resource has not been required in the past even though access was authorized, these may optionally be eliminated from the new or revised grouping.

A further aspect includes a method where cluster analysis, neural analysis and general statistical techniques are performed on working sets of data to enable the identification of common clusters of users and resources associated with the organizational context under evaluation.

A further aspect includes a method where groupings are automatically generated for an entire organization or any part therein based upon a predetermined rule set. The proposed groupings are derived using a method of analyzing both the current authorizations and actual usage to determine real needs and common likely needs for the business function associated with this grouping. This is made possible by having the information available regarding both current access rights and actual utilization patterns.

A further aspect includes a method of delivering the rules by which a grouping can be automatically or manually assigned to new users based upon the organizational context rules used in determining the user set for which this grouping was developed. One aspect of the deliverable being an identification label assigned to the rule set and a list of rules identifying the selection criteria associated with organizational attributes and associated boolean logic for the exercise therein. A further aspect includes a method of delivering the list of current users which should have this grouping assigned. One deliverable may comprise an identification label assigned to the grouping, and a membership table of individuals to which this grouping applies.

A further aspect includes a method of delivering a table of all resources and related permissions that are assigned to this grouping. The deliverable being the identification label assigned to the grouping, and a membership list of all resources and related permissions to be granted when this grouping is applied.

A further aspect includes a method for refining existing groupings via a means of detecting conditions where current authorizations are in excess of actual requirements. This method enables the means to continuously monitor the health of the existing groupings, thereby facilitating a means to refine existing groupings of users and authorizations that are in non compliance to company polices.

A further aspect includes a method of determining if any of the proposed groupings contain a combination of resources considered to be in conflict with effective company policies such as separation of duty rules HIPPA rules etc. as determined by a rules engine (also referred to as a Contouring Engine). When any of these conditions are detected, one or more of the resources may be removed and returned to the pool of un-assigned resources which may in turn be further analyzed to identify commonality among a smaller population of user/resource combinations.

A still further aspect includes generating a report on proposed new group assignments and rules. The report may be used in assigning the proposed groupings to a user associated with the platform(s) or application(s) being restructured. This information may also be provided in various electronic formats capable of dynamic uploading into one or more applications or directories, which may use the proposed groupings for determining access control.

A still further aspect includes a method to produce an output of the proposed groupings consisting of 1.) The rules used to apply the groupings. 2.) The proposed identities to which the groupings should be assigned. 3.) The list of resources and permissions to be authorized when assigned this grouping. The proposed groupings may be free of policy conflicts as defined in the rules engine. This information may also be provided in electronic formats as mentioned above.

A further aspect of the systems and methods is that the rules engine can optionally be used to determine if company policies are being adhered to such as separation of duties, as well as regulatory mandates regarding access controls such as Sarbanes Oxley, HIPAA (Health Insurance Portability and Accountability Act of 1996), GLBA (Gramm-Leach Bliley Act ) etc.

The present invention describes systems, clients, servers, methods, and computer-readable media of varying scope. In addition to the aspects and advantages of the present invention described in this summary, further aspects and advantages of the invention will become apparent by reference to the drawings and by reading the detailed description following.

### Operating Environment

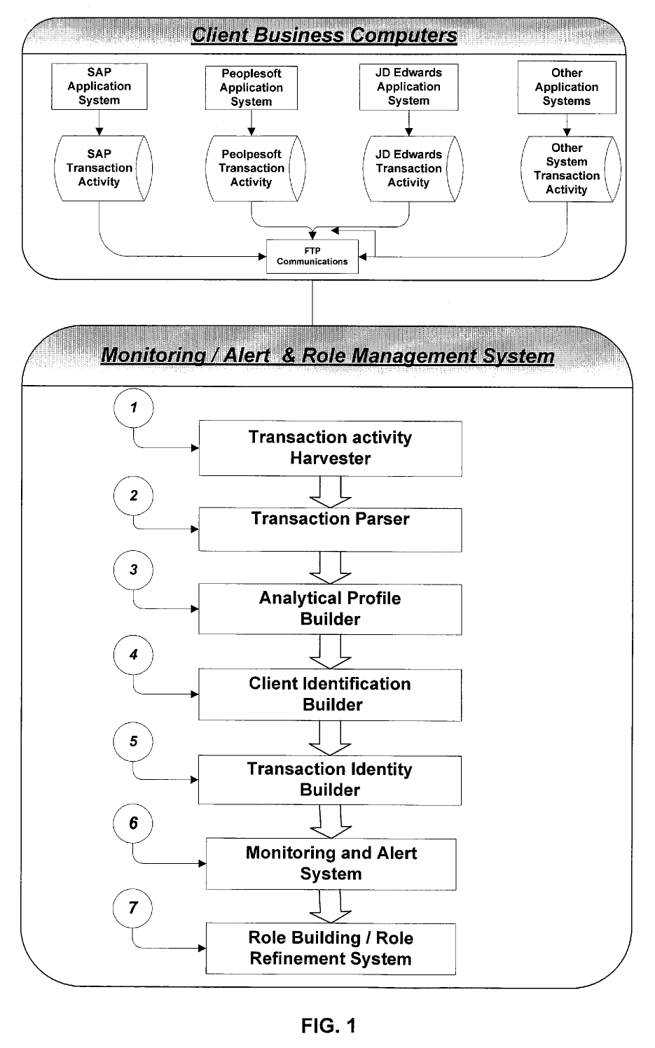

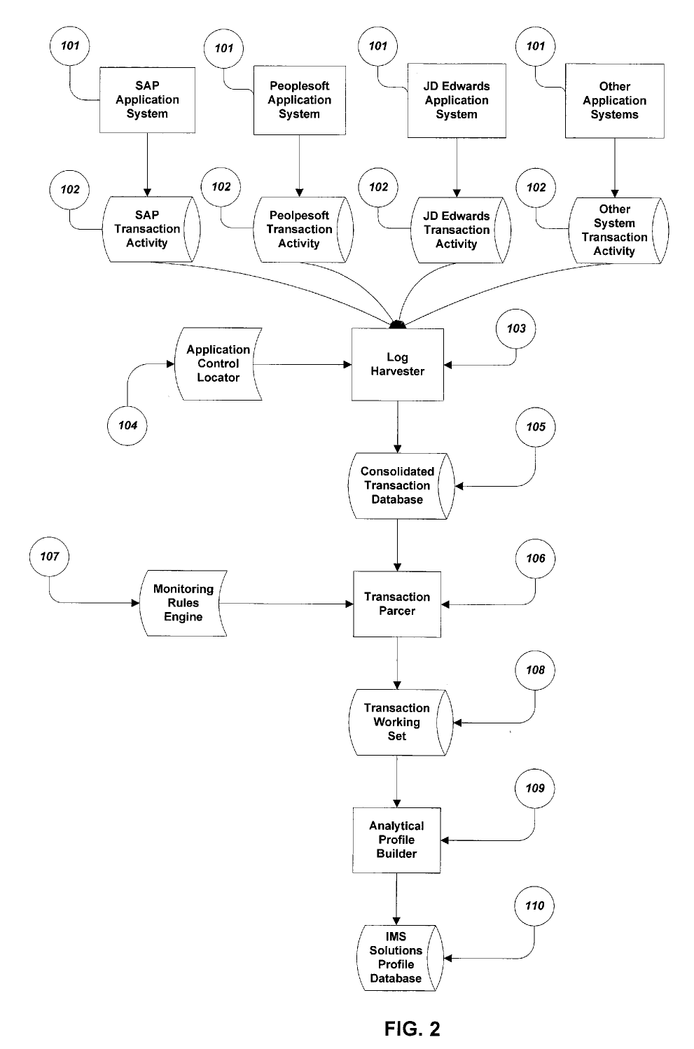

FIG. 1 shows a functional block diagram of the overall processing of a method and the major modules constituting a transaction monitoring and alert system according to an embodiment of the invention. The method begins with the capture of activities related to the gaining access to the application by capturing information related to the access and authentication process performed at the firewall, operating system, directory system and/or network operating system level, as well as transaction level data within one or more of a targeted set of applications residing on application and database servers that may reside within the confines of a business. Such transaction activity may include information on the specific activity the user performed in the course of executing the transaction and the forensic trail of how they gained access to the application. Examples of such information includes: what platform was accessed, what application was accessed, what account was accessed, what file or folder was accessed, what part number or purchase order etc. Further details about this process are provided in FIG. 2.

When all desired transaction activity captured for targeted platforms and applications, the activity information is then transmitted to the Contouring Engine for further processing. In some embodiments of the invention, an FTP (File Transfer Protocol) is used to transfer the data. However, the invention is not limited to any particular file transfer mechanism. In further embodiments, the activity data is encrypted prior to transmission. In addition, in some embodiments, the systems and methods described below may be executed on the same system as the software application generating the transaction. In these embodiments, transaction transfer is not necessary.

After activity data has been transferred, the monitoring and alert system begins an analytical process which, in some embodiments, comprises seven major process activities, which in some embodiments is executed as part of what is referred to as a Contouring Engine. These major process activities include a transaction activity harvester 1, a transaction activity parser 2, an analytical profile builder 3, a client identification builder 4, a transaction identity builder 5, a monitoring and alert system 6, group building/refinement system 7. Some or all of these processes may operate in near real time to detect unusual transaction activity of trusted users within a specific computer application.

FIG. 2 shows a block diagram of an activity profile builder according to an embodiment of the invention for developing user profiles of transaction activity within specific applications being monitored. In some embodiments, an activity profile builder comprises three functions, the first being the collection of transaction activity 101. The transaction activity includes access and authentication activity which may be maintained by a firewall, operating system, application, directory and/or network operating systems utilized by the particular installation. In some embodiments, transaction activity from firewalls may be collected. Examples of network operating systems include the Novel Network Operating system. Examples of operating systems from which access, authentication, and application runtime activity may be obtained include various versions of UNIX operating systems, including Linux and AIX and the Windows family of operating systems from Microsoft Corporation.

In addition, the transaction activity may include transaction level activity within an application or application suite, such as SAP, PeopleSoft, or JD Edwards Active Directory, RACF, ACF2, Access Manager, PeopleSoft, SAP, JD Edwards, Oracle, Great Plains, Lotus Notes, Baan, Siebel, Lawson or Ariba applications software. The invention is not limited to any particular application, application suite or operating system. For example, other applications with high risk proprietary and financial information can be adaptable to the systems and methods of the invention. In some embodiments, the capturing of this activity into the transaction activity files 102 may be accomplished using either or both of two methods. Additional methods may be implemented if changes to operating systems and applications allow. The first method involves capturing the transaction related information within the transaction handler function of the operating system or application being monitored.

The second method of gathering the necessary information may be accomplished through transaction audit logs that may be an inherent function within the firewall, operating system, directory management system or network operating system and application. In some embodiments, the transaction activity log harvester 103 collects the transaction activity on the system hosting the application. The period of time for which this activity is to be performed is determined from the application control locator 104, which in some embodiments controls such functions as what applications are to be monitored, what company or companies are being monitored, transaction log file format indicator, the frequency of performing the monitoring function, the period of time to be utilized in developing the initial profile of the user, frequency of transaction identity synchronization, days to next synchronization, frequency of client resynchronization, days to next synchronization and other pertinent application and company information deemed appropriate. Each company and application may have varying periods of time to effectively establish the baseline of activity depending on the business cycle related to the application. In some embodiments, the transaction activity harvester module 103 utilizes generally available communications software and encryption technologies to securely transfer information to the host based monitoring application. In some embodiments, the transaction activity log harvester 103 also performs verification of data upon receipt, and consolidates all transactions related to the applications being monitored within the consolidated database 105. The transaction parser 106 may then be invoked to analyze the individual records being monitored utilizing the monitoring rules engine 107 to determine if the transaction should be passed on for further review, thereby eliminating transactions pre-determined by the rules database as insignificant to the monitoring process. In some embodiments, rules that may be applied include but are not limited to rules that filter transactions that are considered insignificant to the monitoring process for this application, such as routine housekeeping transactions for printing, memory management etc.

Those records eligible for further monitoring are then output to the transaction working set database 108. The analytical profile builder 109 may then be invoked to create or update the specific user profile of the transaction activity within the monitored firewall, operating system, directory or network operating system and application. An exemplary uniform format for the profile database 110 is shown below in table 1.

TABLE 1
Analytical Profile Database

| Field | Description |
|---|---|
| P_Company_ID | Identifier of company being monitored. |
| P_Application_ID | Identifies the application (i.e.: SAP, Novel |
| | NOS, firewall, Windows, Peoplesoft etc.) |
| P_User_ID | Identifies the user of the transaction. |
| P_Transaction_ID | Identifier for transaction. |
| P-Trans_Auth_Start_Date | Temporary Authorization Start Date |
| | (MMDDYY) |
| P-Trans_Auth_Stop_Date | Temporary Authorization Stop Date |
| | (MMDDYY) |
| P_Transaction_Class | Transaction risk severity |
| P_Date_Month | Month of last transaction activity (MM) |
| | Range (1–12) |
| P_Date_Day | Day of last transaction activity. (DD) Range |
| | (1–31) |
| P_Date_year | Year of last transaction activity (YYYY) |
| P_Date_Minute | Minute of last transaction activity (MM) |
| | Range (0–59) |
| P_Date_Second | Second of last transaction activity (SS) |
| | Range (0–59) |
| P_Date_Month_Init | Month of initial Transaction (MM) |
| | Range (1–12) |
| P_Day_Day_Init | Day of Initial Transaction (DD) |
| | Range (1–31) |
| P_Date_year_Year | Year of last transaction activity (YYYY) |
| P_Number_Transactions | Number of transactions executed. |
| P_Terminal_ID | Terminal ID of last transaction. |
| P_Parameter | Access Parameters of Last Access. |
| P_Domain | Domain - LPAR etc. |
| P_Server | Server ID |
| P_Frequency | Access Frequency |
| P_Group-Name | Authorizing Group |

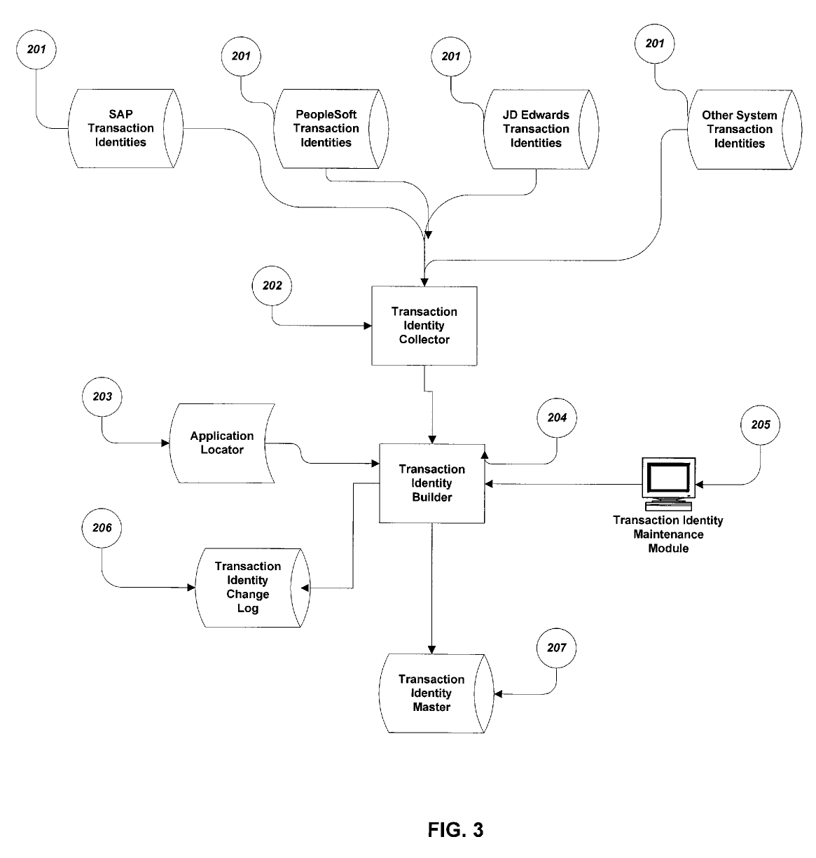

FIG. 3 shows a block diagram of a transaction identification builder and maintenance function according to various embodiments of the invention. In some embodiments, the transaction identity builder 204 comprises three major functions. In some embodiments, the first task in the process involves the extraction of the transaction identity related data 201 from the application server for the application being targeted for monitoring. In some embodiments, transaction identity related data 201 may also include identity data extracted from a network operating system, firewall, or computer operating system. The transaction identity collector module 202 may be invoked periodically and interrogates the application locater database 203 to determine when and what applications transactions are to be extracted from the target company. In some embodiments, the collector module is invoked daily. If scheduled for this time period, the collector determines if this is a resynchronization run or the initial load. In some embodiments, the collector module utilizes generally available communications software and encryption technologies for the secure transfer of information to the host based monitoring application. The transaction identity collector performs verification of data upon receipt, and initiates create or change mode within the application depending on whether resynchronization or initial load has been requested. The initial load option will populate the transaction identity master file 207 with all transaction identities and related information. If resynchronization has been requested, the collector module interrogates the transaction identity master database 207 to determine if the record already exists. If the record does exist, the data elements within the database are synchronized with the data from the receiving file and any changes are logged to the transaction identity change log 206. If the transaction identity master record does not exist, the entry to the transaction identity master database 207 is made and the new transaction identity is logged within the transaction identity change log 206. The transaction identity builder module 204 may also be invoked upon request from the transaction identity maintenance module 205 to maintain transaction identity master records 207 should the need arise between synchronization processes. Likewise all new entries and changes may be logged to the identity change log 206. An exemplary uniform format for the transaction identity database is shown below in table 2.

TABLE 2
Transaction Identity Database

| Field | Description |
|---|---|
| TC_Company_ID | Identifier of company being monitored. |
| TC_Application_ID | Identifies the application (i.e.: SAP, Peoplesoft |
| | etc.) |
| TC_Tansaction_ID | Identifier for transaction. |
| TC_Description | Description of Transaction |
| TC_License | Software License Group |
| TC_Classification | Transaction risk severity |
| TC_User_ID | User Id or source of the update transaction. |
| TC_Date_Month | Month of last transaction activity (MM) Range |
| | (1–12) |
| TC_Date_Day | Day of last transaction activity. (DD) Range |
| | (1–31) |
| TC_Date_year | Year of last transaction activity (YYYY) |
| TC_Date_Minute | Minute of last transaction activity (MM) Range |
| | (0–59) |
| TC_Date_Second | Second of last transaction activity (SS) Range |
| | (0–59) |
| TC_Date_Month_Init | Month of initial create (MM) Range (1–12) |
| TC_Day_Day_Init | Day of Initial create (DD) Range (1–31 |
| TC_Date_year_Year | Year of last create (YYYY) |
| TC_Frequency | Frequency of Use |
| TC_Sensitivity_Class | Sensitivity of the Resource |

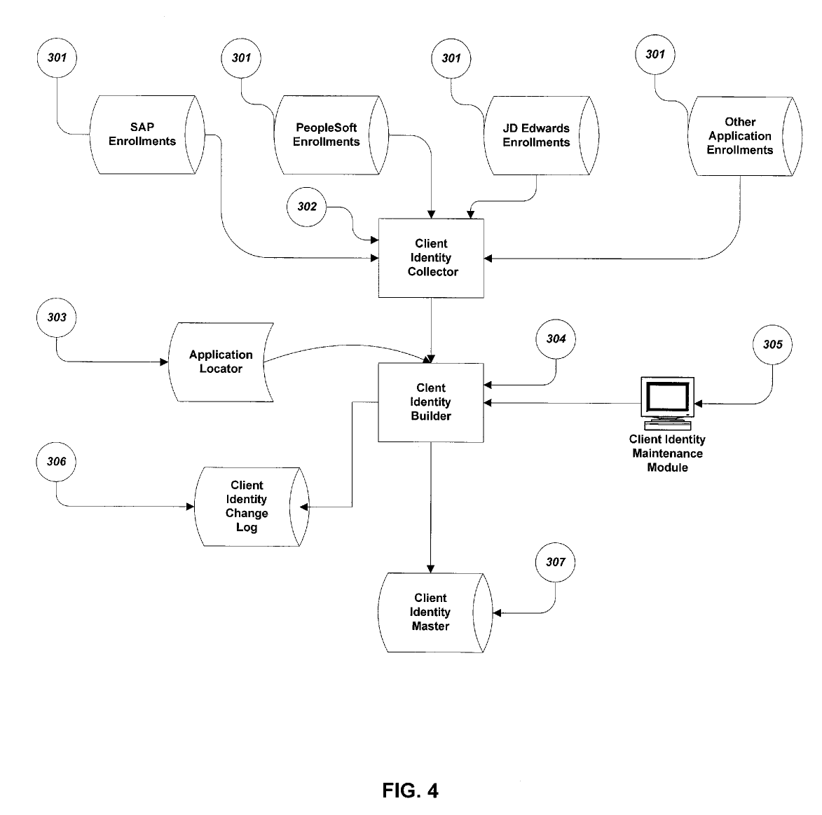

FIG. 4 shows a block diagram of a client identification builder and maintenance function according to various embodiments of the invention. In some embodiments, the client identification builder comprises three major functions. In some embodiments, the first task in the process involves the extraction of the client identity related data 301 from the application being targeted for monitoring. In some embodiments, client identity data 301 may be extracted from one or more of an operating system, application, network operating system, or firewall system. The client identity collector module 302 may be invoked periodically (for example daily) and interrogates the application locater database 303 to determine when and what applications clients are to be extracted from the target company. If scheduled for this time period, the collector determines if this is a resynchronization run or the initial load. In some embodiments, the collector module utilizes generally available communications software and encryption technologies to perform secure transfer of the information to the host based monitoring application. In some embodiments, the client identity builder 304 performs verification of data upon receipt, and initiates create or change mode within the application depending on whether synchronization or initial load has been requested. An initial load option may populate the client identity master file 307 with all client identities and related information. If synchronization has been requested, the collector module interrogates the client identity master database to determine if the record exists. If the record (i.e. table entry) does exist the data elements within the database are synchronized with the data from the receiving file and any changes are logged to the client identity change log 306. If the client identity master does not exist, the entry to the client identity master is made and the new client identity may be logged within the transaction identity change log 306. The client identity maintenance module 305 may be invoked upon request to maintain client identity master records when the need arises between synchronization processes. Likewise all new entries and changes are logged to the identity change log 306. An exemplary uniform format for the client identity master database is shown in table 3 below.

TABLE 3
Client Identity Database

| Field | Description |
|---|---|
| CI_Company_ID | Identifier of company being monitored. |
| CI_User_ID | Identifies the user. |
| CI_User_Name | User Name. |
| CI_Dept | Department the user is assigned to. |
| CI_Location | Location |
| Attribute01 | Organizational Attribute one. |
| Attribute02 | Organizational Attribute two. |
| Attribute03 | Organizational Attribute three. |
| Attribute04 | Organizational Attribute four. |
| Attribute05 | Organizational Attribute five. |
| Attribute06 | Organizational Attribute six. |
| Attribute07 | Organizational Attribute seven. |
| Attribute08 | Organizational Attribute eight. |
| Attribute09 | Organizational Attribute nine. |
| Attribute10 | Organizational Attribute ten. |
| CI_Term_Date | Termination Date. (MMDDYY) |
| CI_Wk_Start | Standard work hour start time. (i.e. 0830) |
| | Military) |
| CI_Wk_Stopt | Standard work hour stop time. (i.e. 0530) |
| | Military) |
| CI_Updt_User_ID | Identifies the user or source of the |
| | transaction. |
| CI_Mon | Monday work (Default = Y) (No = N) |
| CI_Tue | Tuesday work (Default = Y) (No = N) |
| CI_Wed | Wednesday (Default = Y) (No = N) |
| CI_Thur | Thursday work (Default = Y) (No = N) |
| CI_Fri | Friday work (Default = Y) (No = N) |
| CI_Sat | Saturday work (Default = Y) (No = N) |
| CI_Sun | Sunday work (Default = Y) (No = N) |
| CI_Date_Month | Month of last transaction activity (MM) |
| | Range (1–12) |
| CI_Date_Day | Day of last transaction activity. (DD) |
| | Range (1–31) |
| CI_Date_year | Year of last transaction activity (YYYY) |
| CI_Date_Minute | Minute of last transaction activity (MM) |
| | Range (0–59) |
| CI_Date_Second | Second of last transaction activity (SS) |
| | Range (0–59) |
| CI_Date_Month_Init | Month of initial create (MM) Range |
| | (1–12) |
| CI_Day_Day_Init | Day of Initial create (DD) Range (1–31 |
| CI_Date_Year_Year | Year of last create (YYYY) |
| CI_Prime_Contact_Name | Primary Contact Name |
| CI_Prime_Email_Addr | Primary Contact E-Mail Address |
| CI_Prim_Phone | Primary Phone No. or Pager No. |
| | (xxx-xxx-xxxx) |
| CI_Second_Contact_Name | Secondary Contact Name |
| CI_Second_Email_Addr | Secondary Contact E-Mail Address |
| CI_Second_Phone | Secondary Phone No. or Pager No. |
| | (xxx-xxx-xxxx) |

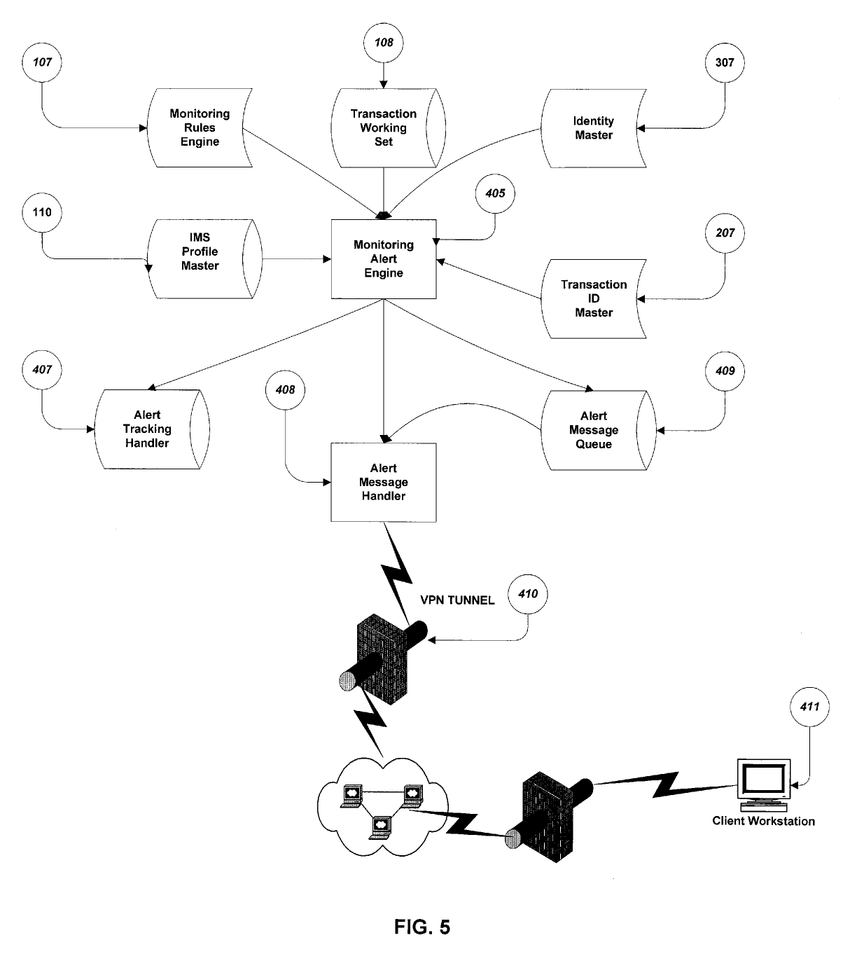

FIG. 5 shows a block diagram of a transaction monitoring and alert system according to an embodiment of the invention. In some embodiments, the transaction monitoring and alert system monitors current transactions against the specific user transaction activity profile for the purpose of detecting access to transactions not been previously initiated in the course of their normal business activities. These normal activity profiles are typically established in the transaction activity profile builder 109 during the listening phase of start up. In some embodiments, the monitoring and alert system utilizes substantially the same process depicted earlier under the profile builder (FIG. 2) to harvest the transaction activity, consolidate and parse the activity from the targeted application to develop the transaction working set 108.

The monitoring and alert system 405 while monitoring each transaction performs a series of analytical processes to determine if there is any abnormal behavior for the specific user. In some embodiments, the system uses inputs from the monitoring rules engine 107 which houses rules be established in a hierarchical fashion, allowing for overall rules to be established at the company level, with the ability to override at the department, individual or transaction level. The client identity master database 307 may be utilized to validate the identity of the user associated with the transaction at the time of initiation, allowing the monitoring system to validate the user has been identified as a trusted user within the given application. The transaction identity master database 207 may be utilized to determine if the transaction executed is a known transaction and the Contouring Engine profile master 110 to determine if the user has been authorized for this transaction. Likewise the transaction identity master database 207 may be used to determine if an attempt to initiate a transaction was denied in accordance with the inherent security built into the application, and more then one attempt was made, indicating the trusted user made repeated attempts to access one or more secured transactions. Additionally, if any of these situations occurs where the client or transaction cannot be identified, or the transaction is not authorized, or represents an anomaly to the profile of the user, an alert message may be directed to the alert message queue 409 with a predetermined severity level assigned, indicating someone has intruded the application by circumventing the authorization procedures. Further analysis may be performed to determine if the transaction activity was initiated by a user identified as “terminated”, if so an alert message is initiated at a predetermined severity level, indicating the employee, vendor, contractor or customer continues to access the transaction within the application after the relationship has ended. Further analysis may be performed to determine if the Contouring Engine profile master indicates this user has been authorized to access this transaction in the past, during the normal course of business. In some embodiments, the monitoring rules engine 107 is utilized to analyze if any rules apply that would override the Contouring Engine profile master 110, restricting access to this transaction for this specific user, this users department, or all users. Further analysis may be performed by the monitoring and alert system 405 utilizing the monitoring rules engine 110 to determine if the transaction was performed during restricted hours of use, or if the activity occurred outside of the normal work hours for the individual. In further embodiments, the monitoring rules engine 107 may provide override capabilities for various monitored conditions, such as the standard work hours with rules related to the specific department assigned to the individual or for temporary assignment of extra authorized hours after analyzing the effective start and end dates for the override. Additionally, temporary authorization to one or more transactions may be authorized for a specific individual. This provides the ability for a specific user to perform transactions when the user or users normally performing those transactions are not able to perform the transactions due to vacations, illness etc.

In addition, in some embodiments, the monitor and alert system may use the above databases to detect if more than one network logon or transaction has been executed by a single user during the same period or overlapping periods of time. Further rules may be applied to determine if transactions have been executed by a specific user from a device that is other than that assigned to the user or normally used by the user.

As can be seen from the above, the activity profiles, in conjunction with Rules Engine and/or database, may be used to define a set of valid transactions for a particular user. Transactions not consistent with the set of valid transactions may be considered an abnormal condition.

If any of these abnormal conditions exist, an alert message queue 409 and the alert tracking handler 407 may be issued with the priority associated with the transaction code classification identified in the transaction identity master 207. In addition, a set of forensic data comprising transaction activity retrieved from a firewall, application, operating system and/or network operating system may be generated for the alert. The set of forensic data includes data useful in determining the path a user took through a network and/or operating system and the access details used when suspicious transaction activity is detected.

In some embodiments, an alert message handler 408 controls the routing of alert messages received from the monitoring alert engine 405 to client workstations 411. In some embodiments, the alert message handler 408 uses a VPN (Virtual Private Network) 410 to send the messages to client workstation 411. However a VPN is not required and in alternative embodiments messages may be sent to client workstation 411 through the Internet, an intranet, or a local area network connection. In further alternative embodiments, the client workstation 411 may be directly connected to the monitoring and alert system.

From the above description, it may be appreciated that the monitoring and alert system may be provided by a service provider that receives the transaction data from a client company. In some embodiments, the service provider may charge the client company based on the volume of transactions monitored, the volume of disk space occupied by the transaction data, or on a per transaction basis. No embodiment of the invention is limited to a particular charging mechanism.

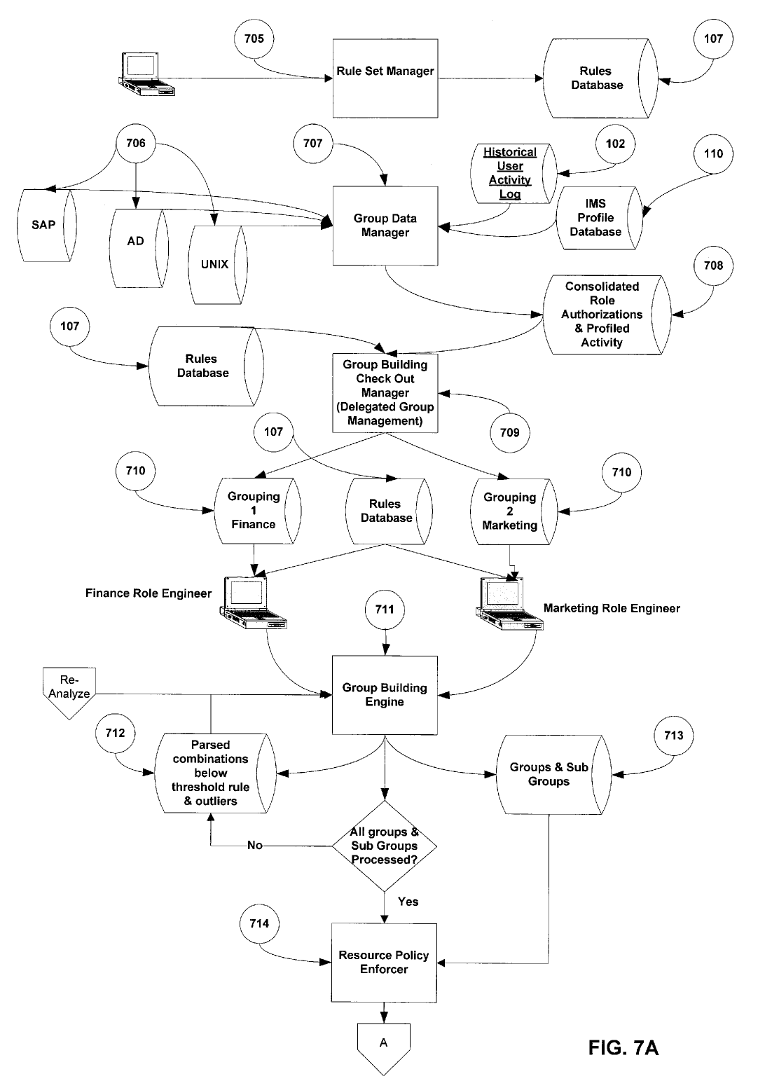

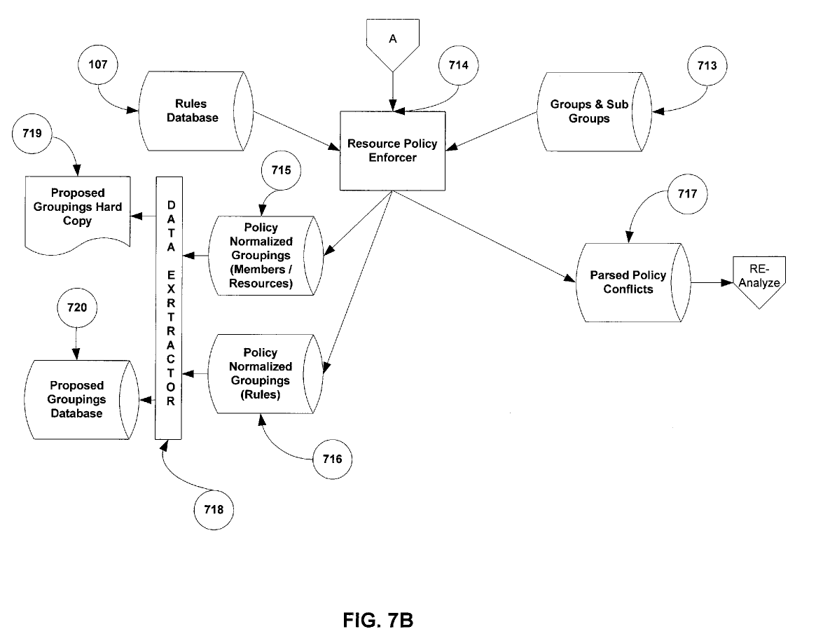

FIGS. 7A and 7B show block diagrams of a group builder/refiner according to embodiments of the invention for developing and refining groupings across specific resources being monitored, or alternatively based upon detailed transaction logs for non-monitored systems. In general, the systems and methods provide the capability for authorities in charge of applications or platforms to easily refine the groupings that are in existence, or suggest proposed groupings based upon actual transaction activity performed upon the resource and contrasted with the current authorizations. The methods may apply to any resource or group of resources for which a grouping is to be established or modified. For the purposes of this specification, network activity is considered just another resource. Thus the same logic applies to network level access of servers, directories, files and folders as it does to accessing an application or transactions contained within. The authorizations and permissions granted to a user may be defined for the purposes of this specification as a grouping. The end result is the establishment of groupings based upon the actual access needs of the individual, rather than the perceived needs, or a combination of the two where desirable. This can in turn improve the security of the digital assets while significantly reducing the time and effort to manually perform such an analysis.

FIGS. 7A and 7B show a functional block diagram of the overall processing of a method and the major modules constituting a group building and refining process according to embodiments of the invention. The method begins with the establishment of rules to be applied during the group building and group refinement process 706. These rules define the organizational context to be applied when developing or refining groupings, the scope of platforms and applications that are to be considered for inclusion in the developed groupings or refined groupings and any rules relative to policy enforcement. The organizational context is defined as a set of attributes to be applied for the identification of a community of users and associated resources to be considered for the assignment or refinement of groupings. The attributes may be organized in a hierarchy. In some embodiments additional criteria is entered to define specific thresholds that must be met for qualification of a grouping proposal. In some embodiments these thresholds would be but are not limited to such things as the minimum number of users a grouping must contain to qualify, additionally the minimum percentage of the total users qualifying for the grouping which access or are currently authorized to access a particular resource. This step of capturing the rules may be performed interactively, and the information collected may be stored in the rules database 107. The Group Data Manager 707 begins with the selection of the source of inputs for the creation of the Consolidated Group Authorizations & Profiled Activity 708. The source can optionally be selected for analysis based upon the user profiles 110 created using the systems and methods described above with reference to FIGS. 1-5, or through the utilization of activity log files 102 generated by an external application. In some embodiments where activity log files 102 are used, the Group Data Manager 707 normalizes the data to a list of unique transactions performed by each user being analyzed. In some embodiments the Group Data Manager 707 accepts data from either source and creates entries in the Consolidated Group Authorizations & Profiled Activity database 708 representing actual activity records for all resources accessed by all users. Step 2 in the Group Data Manager 707, invokes an extract of all current authorizations and permissions from various platforms and applications, using a combination of agents and agent-less technologies. The determination is based upon the specific platforms from which the information is being extracted. In some embodiments, a generally available off the shelf software process is utilized to perform this activity. The extraction of the overall current authorizations for all users is then consolidated with the actual activity within the Consolidated Group Authorizations & Profiled Activity Database 708. After the Consolidated Group Authorizations & Profiled Activity database 708 has been established, the process for group building/refinement begins with an initial step of checking out a specific rule set using the group building check out manager 709, for the purpose of building or refining a particular grouping or groupings. The working set of information is parsed to independent data structures 710 for analytical processing by the group building engine 711. This process assures that concurrent activities are not being performed against the same working set of users and resources. In some embodiments, the group building engine 711, performs an analysis of user/transaction/permissions associated with activities the working set of users actually perform in the course of their daily activities, joined with the current authorizations or permitted activities that the same working set of users are entitled to perform within a given organizational entity for a single or multiple applications. The results of the statistical analysis identify clusters of users and resources/permissions where there actual usage patterns and or their current entitlements are common. With each combination, the statistical percentage of user participation is calculated and made available for applying rules relative to percentage of participation or minimum membership. In some embodiments, the Group Building Engine 711 performs statistical analysis to determine common transactions. In alternative embodiments, a neural network analysis and or group clustering analysis may be used to determine commonality.

After analyzing the various potential combinations, the Group Building Engine 711 begins the process of applying rules to determine if the results produced meet the minimum thresholds established. In some embodiments, a rule may be applied to determine if the resource being analyzed is classified as sensitive and if so the resource is excluded from the group if the condition exists where any single user within this grouping of users does not actively access the resource or is not currently entitled to do so. For all combinations not meeting the rules applied, the working set is placed on the parsed combinations below the threshold file 712 and made available for next iteration of sub group analysis. In some embodiments, those combinations that pass the rules test are placed on the output file groupings & sub groupings 713 for passing on to the resource policy enforcer 714. In some embodiments, the group building engine evaluates the rule set upon which the analysis is being performed to determine if all sub groupings have been exhausted, if not the next sub grouping is processed using the remaining working set of users and resources, including those parsed for failing the rules test. If all have been exhausted, then control is passed to the resource policy enforcer 714. The resource policy enforcer 714 provides a mechanism to introduce rules to be applied for the purpose of enforcing company policies regarding entitlement management. Rules established by the rule set manager 705 are applied to the newly constructed grouping or groupings to insure that all policies are supported within the grouping or groupings being proposed. In some embodiments, a Separation of duties analyzer may use rules defined by external regulations as a basis for detecting conflicts. For example, in some embodiments, the SOD conflicts may be determined based on rules established according to the Sarbanes-Oxley act of 2002. In alternative embodiments, policy conflicts may be determined based on rules established according to the Health Insurance Portability and Accounting Act (HIPAA) of 1996. In further embodiments, the policy conflicts or rules may be established in accordance with the Gramm-Leach Bliley Act (GLBA). In other alternative embodiments, any compliance regulation whether mandated by law or company policy may be established within the rules data base 107 and applied within the resource policy enforcer. In some embodiments, the resource policy enforcer accepts as input the suggested groupings & sub groupings 713 and applies all policies established within the rules database 107 for the purpose of identifying conflicts with policy. When a conflict is detected, the resource policy enforcer 714 will determine which of the two or more resources is used the least and parse's this transaction to the Parsed Policy Conflicts database 717. As each group is analyzed and parsed of conflicts, the policy normalized grouping creates two primary outputs, the first being the policy normalized groupings (Members and Resources) 715 containing the table of resources to be authorized by this grouping and a table of the members to whom this grouping should be assigned. The second output consisting of a table of rules to be applied when provisioning a new user are created in the policy normalized (rules) database 716. For those items parsed from the proposed groupings due to policy conflicts, each is written to the parsed policy conflicts database 717 which in turn is made available to the group building engine for the next iteration of sub grouping development.

In some embodiments, the data extractor 718 determines the output formats to be utilized by interrogating the rules database 107. In some embodiments, the rules may dictate that the output be formatted per the SOAP (Simple Object Access Protocol) which acts as a transport mechanism to send data between applications or from applications to people. SOAP, along with Extensible Markup Language (XML) may be used or alternative formats to suit the receiving systems input requirements and entered into the proposed groupings database 720. In an alternative embodiment, the output may be delivered to any hardcopy device 719.

In some embodiments, one output of the above described method is a set of groupings that may be applied to system and application users. In addition, the output may be used to modify previously existing groupings, adding rights or deleting rights when the analysis considers it appropriate to do so. Further, the output may be used to generate rules for associating new users to appropriate groupings.

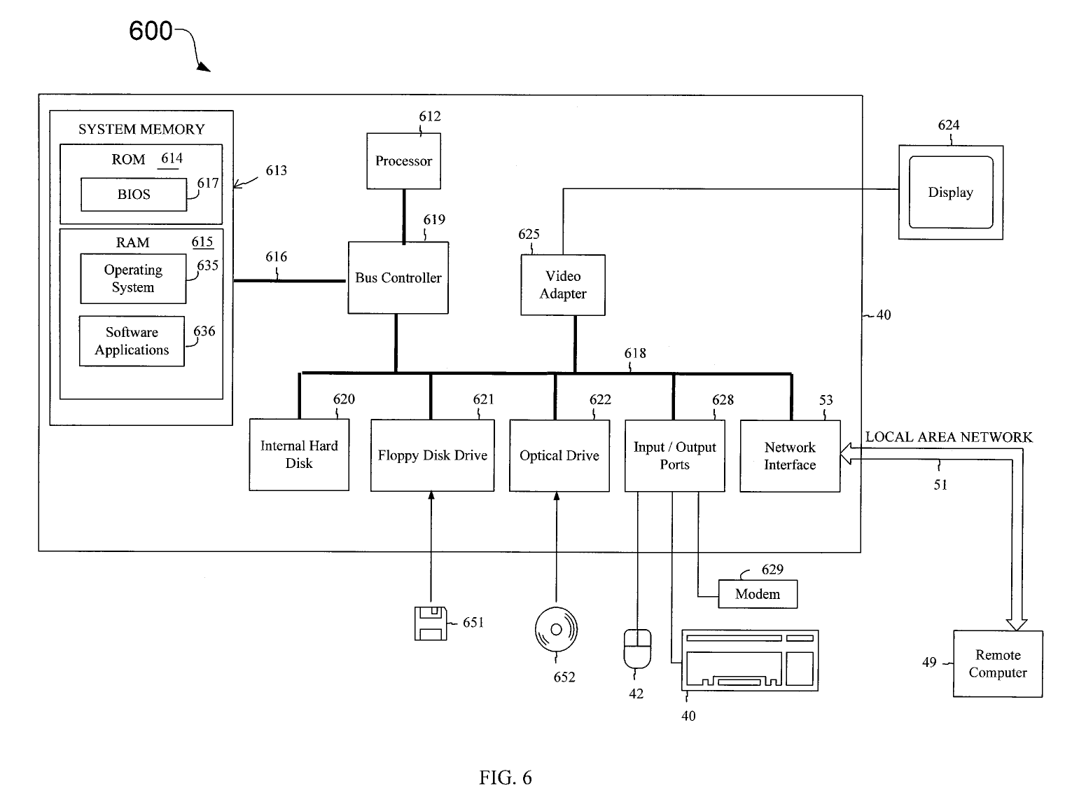

FIG. 6 is a diagram of the hardware and operating environment in conjunction with which embodiments of the invention may be practiced. The description of FIG. 6 is intended to provide a brief, general description of suitable computer hardware and a suitable computing environment in conjunction with which the invention may be implemented. Although not required, the invention is described in the general context of computer-executable instructions, such as program modules, being executed by a computer, such as a personal computer or a server computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

As shown in FIG. 6, the computing system 600 includes a processor. The invention can be implemented on computers based upon microprocessors such as the PENTIUM® family of microprocessors manufactured by the Intel Corporation, the MIPS® family of microprocessors from the Silicon Graphics Corporation, the POWERPC® family of microprocessors from both the Motorola Corporation and the IBM Corporation, the PRECISION ARCHITECTURE® family of microprocessors from the Hewlett-Packard Company, the SPARC® family of microprocessors from the Sun Microsystems Corporation, or the ALPHA® family of microprocessors from the Compaq Computer Corporation. Computing system 600 represents any personal computer, laptop, server, or even a battery-powered, pocket-sized, mobile computer known as a hand-held PC.

The computing system 600 includes system memory 613 (including read-only memory (ROM) 614 and random access memory (RAM) 615), which is connected to the processor 612 by a system data/address bus 616. ROM 614 represents any device that is primarily read-only including electrically erasable programmable read-only memory (EEPROM), flash memory, etc. RAM 615 represents any random access memory such as Synchronous Dynamic Random Access Memory.

Within the computing system 600, input/output bus 618 is connected to the data/address bus 616 via bus controller 619. In one embodiment, input/output bus 618 is implemented as a standard Peripheral Component Interconnect (PCI) bus. The bus controller 619 examines all signals from the processor 612 to route the signals to the appropriate bus. Signals between the processor 612 and the system memory 613 are merely passed through the bus controller 619. However, signals from the processor 612 intended for devices other than system memory 613 are routed onto the input/output bus 618.

Various devices are connected to the input/output bus 618 including hard disk drive 620, floppy drive 621 that is used to read floppy disk 651, and optical drive 622, such as a CD-ROM drive that is used to read an optical disk 652. The video display 624 or other kind of display device is connected to the input/output bus 618 via a video adapter 625.

A user enters commands and information into the computing system 600 by using a keyboard 40 and/or pointing device, such as a mouse 42, which are connected to bus 618 via input/output ports 628. Other types of pointing devices (not shown in FIG. 6) include track pads, track balls, joy sticks, data gloves, head trackers, and other devices suitable for positioning a cursor on the video display 624.

As shown in FIG. 6, the computing system 600 also includes a modem 629. Although illustrated in FIG. 6 as external to the computing system 600, those of ordinary skill in the art will quickly recognize that the modem 629 may also be internal to the computing system 600. The modem 629 is typically used to communicate over wide area networks (not shown), such as the global Internet. The computing system may also contain a network interface card 53, as is known in the art, for communication over a network.

Software applications 636 and data are typically stored via one of the memory storage devices, which may include the hard disk 620, floppy disk 651, CD-ROM 652 and are copied to RAM 615 for execution. In one embodiment, however, software applications 636 are stored in ROM 614 and are copied to RAM 615 for execution or are executed directly from ROM 614.

In general, the operating system 635 executes software applications 636 and carries out instructions issued by the user. For example, when the user wants to load a software application 636, the operating system 635 interprets the instruction and causes the processor 612 to load software application 636 into RAM 615 from either the hard disk 620 or the optical disk 652. Once software application 636 is loaded into the RAM 615, it can be used by the processor 612. In case of large software applications 636, processor 612 loads various portions of program modules into RAM 615 as needed.

The Basic Input/Output System (BIOS) 617 for the computing system 600 is stored in ROM 614 and is loaded into RAM 615 upon booting. Those skilled in the art will recognize that the BIOS 617 is a set of basic executable routines that have conventionally helped to transfer information between the computing resources within the computing system 600. These low-level service routines are used by operating system 635 or other software applications 636.

In one embodiment computing system 600 includes a registry (not shown) which is a system database that holds configuration information for computing system 600. For example, Windows® 95, Windows 98®, Windows® NT, Windows 2000® and Windows XP® by Microsoft maintain the registry in two hidden files, called USER.DAT and SYSTEM.DAT, located on a permanent storage device such as an internal disk.

### Conclusion

Systems and methods for associating transactions and corresponding user identities with groupings are disclosed. Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention.

The terminology used in this application is meant to include all of these environments. It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

We claim:

1. A method comprising:
receiving transaction activity;
analyzing the transaction activity by comparing actual utilization of one or more transactions in the transaction activity to a permitted list of transactions to determine a set of one or more transactions to be assigned to a grouping,
assigning the set of one or more transactions to the grouping; and
assigning the grouping to one or more users.

2. The method of claim 1, further comprising summarizing detailed activity within the transaction activity into one or more user profiles representing typical use.

3. The method of claim 1, wherein assigning the set of one or more transactions to the grouping includes associating user identifications with the grouping.

4. The method of claim 1, wherein one or more rules are applied to identify a set of users, wherein the set of users are organized according to an organization membership; and
further comprising assigning a subset of the set of users to a grouping according to the organization membership.

5. The method of claim 4, wherein the organization membership includes a membership selected from the group consisting of: company, division, business unit, department or job code.

6. The method of claim 1, wherein the grouping includes an existing role or directory group.

7. The method of claim 1, further comprising identifying one or more rules to be utilized for automatically assigning the grouping when provisioning a new user.

8. The method of claim 1, wherein the grouping comprises a role or directory group.

9. The method of claim 1, wherein the transaction activity includes activity selected from at least one of the group consisting of: transaction activity related to the use of a computer application by a user, firewall activity, directory activity, access management activity, web server activity, network operating system activity, or operating system activity.

10. The method of claim 9, wherein the computer application includes computer applications selected from the group consisting of Active Directory, RACF, ACF2, Access Manager, PeopleSoft, SAP, JD Edwards, Oracle, Great Plains, Lotus Notes, Baan, Siebel, Lawson or Ariba.

11. The method of claim 1, wherein analyzing the transaction activity comprises performing a statistical analysis of transaction activity and permitted access rights.

12. The method of claim 1, wherein analyzing the transaction activity and the permitted access rights includes one or more of: performing a neural network analysis, group clustering analysis, iteration or the application of fuzzy logic related to the transaction activity.

13. The method of claim 1, further comprising:
analyzing the assignment of the set of one or more transactions to a grouping for one or more corporate policy rules violations; and
removing from the grouping at least one of the set of one or more transactions that violate the one or more corporate policy rules.

14. The method of claim 13, wherein the corporate policy rules include one or more separation of duties rules.

15. The method of claim 13, wherein the corporate policy rules conform to company directed compliance policies, legislated compliance laws or generally accepted accounting practices.

16. The method of claim 15, wherein the legislated compliance law includes at least one of: the Sarbanes-Oxley act of 2002, HIPAA or GLBA.

17. The method of claim 7, further comprising providing a report file regarding the assignment of the set of one or more transactions to a grouping, a set of users qualifying for the assignment of the grouping and the rules to be used for automatically assigning the groupings when provisioning new users.

18. The method of claim 17, further comprising uploading the report file to an application.

19. The method of claim 1, wherein assigning the set of one or more transactions to the grouping modifies an existing grouping.

20. A computer-readable medium having computer executable instructions for causing one or more processors to perform a method, the method comprising:
receiving transaction activity;
analyzing the transaction activity by comparing actual utilization of one or more transactions in the transaction activity to a permitted list of transactions to determine a set of one or more transactions to be assigned to a grouping; and
assigning the set of one or more transactions to the grouping.

21. A system comprising:
A group data manager operable to receive a set of transaction activity representing actual access patterns and to produce a set of activity records for a set of users; and
a group building engine operable to:
receive a set of permitted activities,
receive the set of activity records,
receive a set of rules,
analyze the set of activity records and the set of permitted activities to determine according to the set of rules a set of one or more transactions to be assigned to a grouping,
assign the set of one or more transactions to the grouping, and
assigning the grouping to one or more users.
